(19) United States
(12) Patent Application Publication
(10) Pub. No.: US 2009/0043603 A1
(43) Pub. Date: Feb. 12, 2009

(54) SYSTEMS AND METHODS FOR COMMERCIAL REAL ESTATE INVESTMENT SERVICES

(75) Inventors: Josh Rutherford, Bothell, WA (US); Bruce Woodcock, Lynden, WA (US); Michael Stain, Everett, WA (US)

Correspondence Address: BLACK LOWE & GRAHAM, PLLC, 701 FIFTH AVENUE, SUITE 4800, SEATTLE, WA, 98104, US

(73) Assignee: Sage Properties, Inc., Woodinville, WA (US)

(21) Appl. No.: 12/188,974

(22) Filed: Aug. 8, 2008

Related U.S. Application Data
(60) Provisional application No. 60/955,002, filed on Aug. 9, 2007.

(51) Int. Cl. G06Q 99/00

(52) U.S. Cl. 705/1

(57) ABSTRACT

Systems and methods are operable to value commercial properties. An exemplary embodiment identifies a type of commercial property based on an identified commercial property, the identified type of commercial property selected from a list of property types, retrieves a plurality of objective valuation parameters and subjective valuation parameters pertaining to the identified type of commercial property, retrieves at least one valuation parameter for the identified commercial property, and values the identified commercial property based upon the at least one valuation parameter for the identified commercial property and based upon the plurality of objective valuation parameters and subjective valuation parameters pertaining to the identified type of commercial property.

### PRIORITY CLAIM

This patent application claims priority from copending U.S. Provisional Patent Application Ser. No. 60/955,002 filed Aug. 9, 2007, and entitled, “Systems and Methods For Commercial Real Estate Investment Services,” the contents of which are hereby incorporated by reference in its entirety.

### BACKGROUND OF THE INVENTION

Commercial property owners, potential investors, and brokers need and want to know the value of commercial property or listings at any time and in a convenient way. They also need to know how current market conditions create and justify property valuations and how to realize that value.

The following are trends that are occurring today in the commercial real estate industry both online and offline: using the Internet as a way of marketing commercial property investments; readily available market knowledge and trends through the Internet; greater increase in inventory of properties for sale and for lease increasing the demand for online search engines; for owners to work with brokers that have a specialized focus (for example, brokers that only sell one property type in one area); rising interest rates leading to a downward market cycle in most property types; an increase in the amount of dollars spent for online advertising in the real estate and financial service sectors; a greater number of commercial real estate brokers and agents creating greater competition for listings.

### BRIEF DESCRIPTION OF THE DRAWINGS

The preferred and alternative embodiments of the present invention are described in detail below with reference to the following drawings.

FIG. 1 is a block diagram illustrating an exemplary embodiment of the commercial property valuation system;

FIG. 2 is a block diagram conceptually illustrating portions of an exemplary memory of the commercial property valuation system;

FIG. 3 is a flow chart illustrating a process for calculating a value of a property;

FIGS. 4A-4G show tables used for calculating the value of a property;

FIG. 5 is a flow chart illustrating in further detail the process for calculating a value of a property; and

FIGS. 6A-6H illustrate exemplary valuation algorithms for various commercial property types.

### DETAILED DESCRIPTION OF THE PREFERRED EMBODIMENT

Systems and methods for real estate investment services are disclosed herein. The system and method includes, but is not limited to property valuation services and/or access to a search engine of property profiles based on data collected from county assessors offices, for sale and for lease listings. In one embodiment a system and method is a web based application.

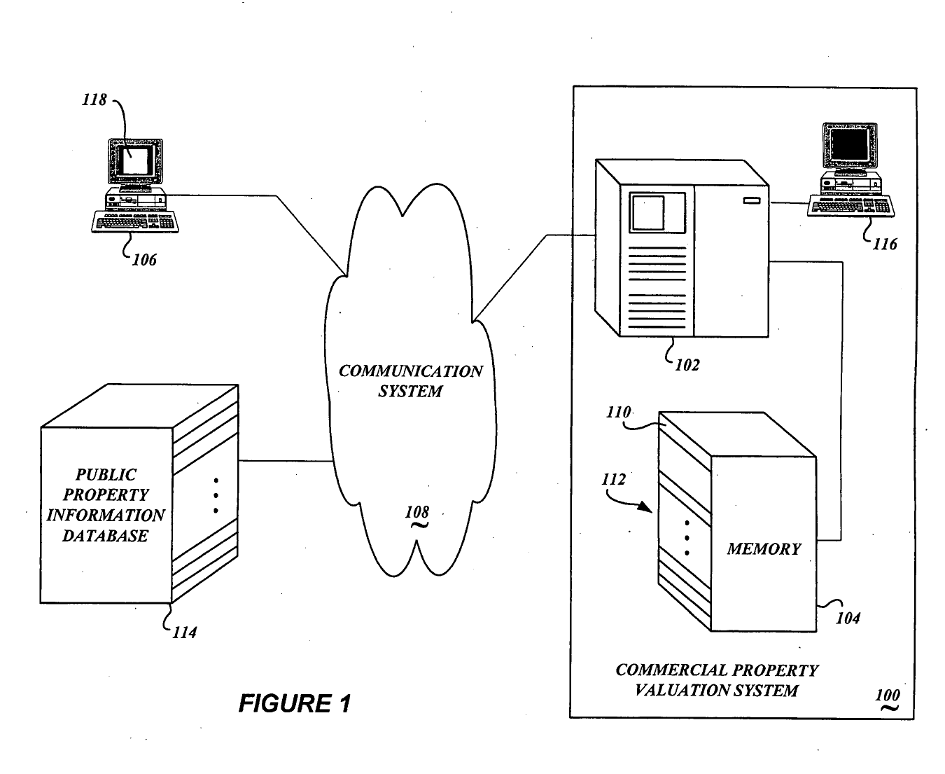

FIG. 1 is a block diagram illustrating an exemplary embodiment of the commercial property valuation system 100. The exemplary embodiment includes a server 102 and a memory 104. The server 102 is accessible by an individual interested in receiving commercial property valuation information at a remotely located computer terminal 106. Communication system 108 communicatively couples the server 102 and the remote computer terminal 106. A commercial property service application 110 and a commercial property database 112 reside in memory 104.

Server 102 may include a processor system or the like. Alternatively, server 102 is a processor system with interfaces that provide coupling to the communication system 108. In yet other embodiments, a processor system, such as a computer terminal 116, is communicatively coupled to the server 102. Server 102 also may include a buffer, memory, or the like that is configured to store information provided by the user. Such information may be restored in other memory, or retrieved for valuation of the commercial property.

In some embodiments, a public property information database 114 is accessible by the server 102, via the communication system 108. Public information pertaining to commercial property of interest may be accessed and retrieved from the public property information database 114 by the server 102. Thus, publicly available information for commercial property of interest may be stored into the memory 104. For example, assessment information, historical sales price or lease price information for the specified commercial property of interest, or other similar commercial property, may be available from the public property information database 114. Assessment information may include attributes of the commercial property, such as type, size of structures and/or lots, location, zoning, and/or use, which was used to establish the assessed basis of the commercial property. The public information may also include ownership contact information, how title is held a closing price and a closing date if the commercial property has previously sold.

In some embodiments, the commercial property valuation system 100 may include, or be coupled to, the computer terminal 116. Thus, a program administrator or other authorized person may access the server 102 and/or the memory 104 to perform various management functions or data processing functions.

The property valuation process is initiated by a user at the computer terminal 106. When the process is started, the commercial property valuation system 100 provides a graphical user information (GUI) template 118 that requests information from a user. The GUI template 118 is filled out by the user and then returned. A variety of GUI templates 118 may be used depending upon the nature of the information that is provided by the user, who may be a seller and/or a buyer of commercial property.

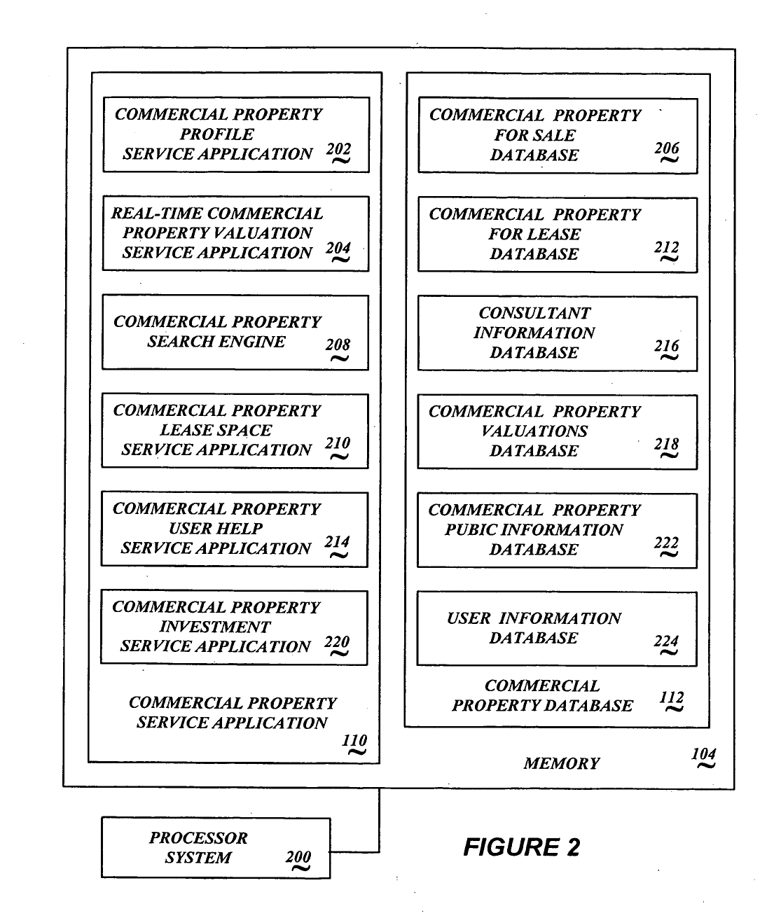

FIG. 2 is a block diagram illustrating portions of the exemplary memory 104 of the commercial property valuation system 100. The commercial property valuation system 100 comprises a processor system 200. The memory 104, communicatively coupled to processor system 200, may be any suitable memory medium, may be a plurality of similar or different memory devices, and/or may reside at any suitable location. For example, in one embodiment, memory 104 is remotely accessed by the server 102, either indirectly via intermediary components (not shown) and/or even via the communication system 108. In another embodiment, memory 104 is an integrated component, and/or communicatively coupled to, the server 102.

FIG. 2 is a block diagram conceptually illustrating portions of an exemplary memory of the commercial property valuation system. Included in the memory 104 are portions that store various service applications, generally denoted as the commercial property service application 110, and portions that store various information, generally denoted as the commercial property database 112.

The commercial property valuation system 100, as disclosed in one embodiment, includes a “Property Profile.” The Property Profile is a commercial property profile service application 202 that may be launched as a web or internet accessible service application, and preferably accesses the commercial property database 112 with various types of commercial property types for the top 100 metropolitan areas in the county. Further, commercial property information may be further classified by population.

This commercial property database 112 is developed by at least the commercial property profile service application 202, which retrieves public information by pulling data from each county's assessor office and other public sources. Public information resides in the public database 114, which may be electronically accessed in instances. In other instances, the information is manually accessed from public electronic records or hard copy records.

The commercial property profile service application 202 may allow users to search for general information on all commercial property types from a convenient remote location, such as the remotely located computer terminal 106 (FIG. 1). This information provided by the commercial property profile service application 202 includes, but is not limited to items such as, property type, property sub-type, year built, address, property name, property condition and description, number of units/rooms, unit/room type, rentable square feet, tenants, rent amount, leasing office contact info, owner's info, sales history, and parcel number.

The commercial property service application 110 further includes a real-time commercial property valuation service application 204. The real-time property valuation service application 204 allows property owners and real estate professionals to have access to a real time commercial property valuation tool for any type of commercial property throughout a geographic region of interest, preferably for the largest 100 metropolitan areas in the country. This real-time commercial property valuation service application 204 preferably provides an opinion of value without having to deal with the hassles and selling pressure of a broker. The real-time property value will be derived from a selected property valuation algorithm, preferably consisting of, but not limited to, the following factors: annual gross revenues, property type, property condition, market type, capitalization rate, and the address of the property. It will also ask who the user is (owner, broker or other).

The commercial property service application 110 accesses a commercial property for sale database 206 for information pertaining to for-sale commercial property. The commercial property for sale database 206 is populated with information pertaining to commercial property listed for sale or for lease. The commercial property for sale database 206 is accessed by the commercial property service application 110 to provide a customer search engine 208 used to look for actively listed commercial properties for sale or lease. Periodic updating of the commercial property for sale database 206 allows current commercial property for sale listings to be entered into the search engine 208 of the commercial property service application 110 to ensure that the owner is getting maximum exposure.

In an alternate embodiment of the commercial property valuation system 100, the system and method further includes a feature for property owners looking to lease space. A commercial property lease space service application 210 matches a lessee's leasing requirements with available commercial properties available for lease. Information pertaining to available commercial property for lease resides in a commercial property for lease database 212.

The commercial property service application 110 further includes a commercial property user help service application 214 feature. The commercial property user help service application 214, interchangeably referred to as “Sage Help,” is designed as a search engine configured to assist the client locate and evaluate consultants, associations, contractors and popular industry topics specific to types of property, geographic locations and areas of specialty. Consultants include, but are not limited to, real estate attorneys, CPA's, property managers, engineers, economists and financial and real estate brokers. Each consultant will be qualified and profiled through a list of questions. The consultant can join the resource directory if he/she is qualified for a small annual fee and have the option to upgrade their advertising. Information pertaining to consultants, preferably pre-qualified, resides in a consultant information database 216. The commercial property user help service application 214 gives the client the contact information of the consultant and a link to the consultant's web site.

Preferably, consultants are prequalified by the administrator or another party before their information is added into the consultant information database 216. Consultant information may include various consultant attributes, such as location, fee structures, areas of expertise, performance history, current listings, education, organization size, and/or images of the consultant and/or of individuals working for the consultant. Other information may be included in the consultant information database 216. Entry into the consultant information database 216 may optionally be fee based. Consultants may be real estate agents or the like, and may be individuals or organizations. Further, experts in other areas may be included in the consultant information database 216, such as builders, inspectors, architects, designers, decorators, suppliers, brokers, agents, appraisers, attorneys, property managers, developers, investors, consultants or the like.

Based upon information input by a user, the user information is compared to the consultant attributes. One or more potential consultants are identified based upon a match of the consultant attributes with the needs of the user, who may be a buyer or seller. For example, if the user is a buyer looking for vacant land, one or more real estate agents specializing in vacant land sales may be identified based on any suitable criteria of interest. Criteria may include geographic proximity to the user of the area where the user is looking for land. Other criteria may include the size, type, use, zoning of the land, representation of the buyer vs. seller, and if representation is for sales or leasing. The user information may be stored in a user information database 224.

In a preferred embodiment, at least three qualified consultants are identified and indicated to the user via the GUI template 118. The user may get contact information for a consultant of interest directly, or be provided suitable contact information. The service may be fee based to the user.

In one embodiment, the commercial property valuation system 100 includes a single computer, interchangeably referred to as a computer terminal or a processor system. In an alternate embodiment, the commercial property valuation system 100 includes a computer in communication with a plurality of other computers. In an alternate embodiment, the computer is connected with a plurality of computers, a server, a database, and/or a network, such as an intranet or the Internet, conceptually illustrated as the communication system 108 (FIG. 1). In yet another alternate embodiment, a bank of servers, a wireless device, a cellular phone and/or another data entry device can be used in place of the computer.

In one embodiment, the commercial property database 112 stores data related to the calculation of Commercial Real Estate Values. That is, information pertaining to determined commercial property valuations resides in a commercial property valuations database 218. The information is continuously or periodically updated. Accordingly, over a period of time, a highly accurate and current database of values for commercial properties as determined by embodiments of the commercial property valuation system 100, in addition to other pertinent information, is created.

The commercial property database 112 can be stored locally at the computer or at any remote locations while being retrievable by the computer terminals 106 or 116. In one embodiment, the commercial property service application 110 is run by the server 102, or by the computer terminals 106 or 116, which then launches a web application process.

The commercial property service application 110 may include a commercial property investment service application 220 that executes to provide a Commercial Real Estate Investment Service. For example, the computer terminals 106 or 116, or the server 102, can retrieve and execute the commercial property investment service application 220 that identifies comparable commercial properties in the area based upon a commercial property interest profile entered by a client. In some embodiments, the commercial property investment service application 220 is operable to process one or more valuation algorithms or valuation formulas for selected commercial properties identified by the commercial property investment service application 220, thereby providing a highly accurate, real-time valuation.

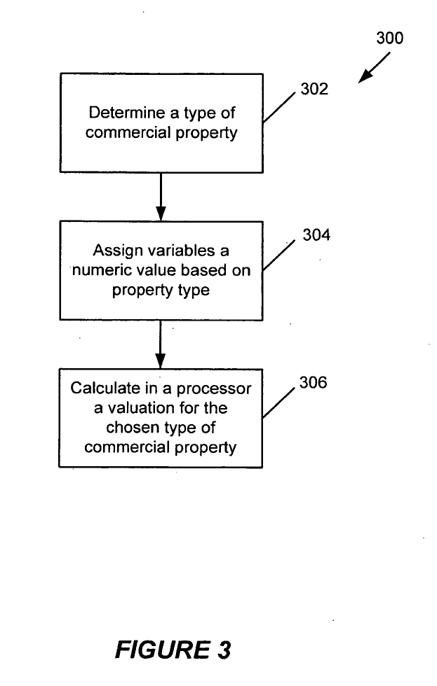

FIG. 3 is a flow chart 300 illustrating a process for calculating a value of a property. At block 302 the type of commercial property is determined based upon input from the user, who has responded to one of the GUI templates 118. The commercial property types include, but are not limited to, apartments, lodging, hospitality, single tenant retail or office valuation, self storage facilities, and/or multi-tenant office/retail/industrial valuation.

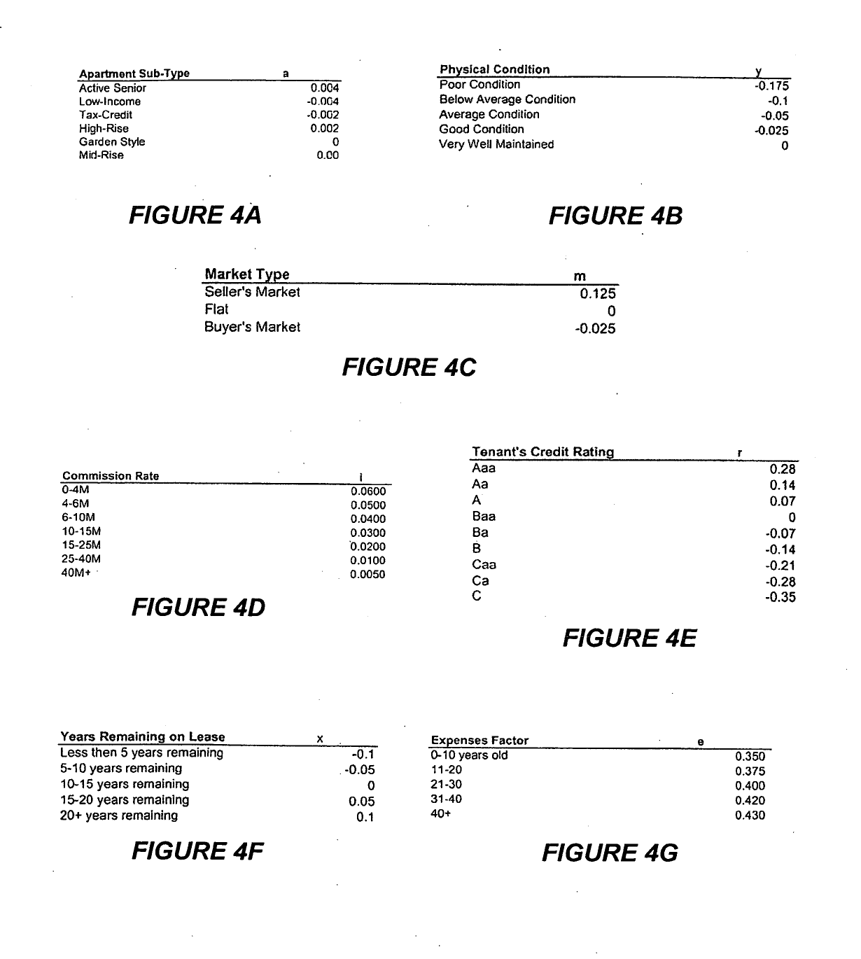

At block 304 variables are assigned a numeric value based on the property type. In one embodiment, apartments have the following variables: Projected Total Annual Revenue (t) which includes rents, laundry, parking, utility reimbursements etc.; an Expense Factor (e) which is based on age and shown in FIG. 4G; Net Operating Income (n) which is calculated by subtracting expenses from total revenues; Cap Rate (c) which is based on the comparable sales in the region and submarket; Current Price (p) which is the net operating income divided by the Cap Rate; Physical Condition (y) which is inputted by a user from a table as shown in FIG. 4B; Commission (i) shown in FIG. 4D; Market Type (m) shown in FIG. 4C; Apartment Sub Type (a) shown in FIG. 4A; Closing Costs which is a constant of 0.02 and net proceeds (f). The formula, in one embodiment is expressed as:

p=[(t−te)/c](1+y+m+a)

f=p−(0.02p)−(ip)

In one embodiment, Single tenant retail or office valuation, have the following variables: Projected Total Annual Revenue (t) which includes rents, laundry, parking, utility reimbursements etc.; an NNN Lease Factor (e) which is based on NNN lease increases; Cap Rate (c) which is based on the comparable sales in the region and submarket; Property Value (p); Tenants Credit Rating (r) which is determined using Moody's Credit Rating System shown in FIG. 4E; Years Remaining on Lease (x) shown in FIG. 4F; Commission (i) shown in FIG. 4D; Market Type (m) shown in FIG. 4C; Apartment Sub Type (a) shown in FIG. 4A; Closing Costs which is a constant of 0.02 and net proceeds (f). The formula, in one embodiment is expressed as:

NNN Lease: p=(t/c)(1+r+x+m)

Full Service Lease: p=[(t−e)/c](1+x+m)

f=p−(0.02p)−(ip)

In one embodiment Self Storage Facilities have the following variables: Projected Total Annual Revenue (t) which includes rents, laundry, parking, utility reimbursements etc.; an Expense Factor (e) which is expressed as a percent of total revenue shown in FIG. 4G; Net Operating Income (n) which is calculated by subtracting expenses from total revenues; Cap Rate (c) which is based on the comparable sales in the region and submarket; Current Price (p) which is the net operating income divided by the Cap Rate; Physical Condition (y) which is inputted by a user from a table as shown in FIG. 4B; Commission (i) shown in FIG. 4D; Market Type (m) shown in FIG. 4C; Apartment Sub Type (a) shown in FIG. 4A; Closing Costs which is a constant of 0.02 and net proceeds (f). The formula, in one embodiment is expressed as:

p=[(t−te)/c](1+y+m+a)

f=p−(0.02p)−(ip)

In one embodiment multi-tenant office/retail/industrial facilities have the following variables: Projected Total Annual Revenue (t) which includes rents, laundry, parking, utility reimbursements etc.; Base Rent (b); Common Area Maintenance (cam); an Expense Factor (e) which is expressed as a percent of total revenue shown in FIG. 4B; Commission (i) shown in FIG. 4D; Market Type (m) shown in FIG. 4C; Apartment Sub Type (a) shown in FIG. 4A; Net Operating Income (n) which is calculated by subtracting expenses from total revenues; Cap Rate (c) which is based on the comparable sales in the region and submarket; Current Price (p) which is the net operating income divided by the Cap Rate; Physical Condition (y) which is inputted by a user from a table as shown in FIG. 4B; Commission (i) shown in FIG. 4D; Market Type (m) shown in FIG. 4C; Apartment Sub Type (a) shown in FIG. 4A; Closing Costs which is a constant of 0.02 and net proceeds (f). The formula, in one embodiment is expressed as:

p=[(b+cam)−(cam*0.9)/c](1+y+m+a)

f=p−(0.02p)−(ip)

At block 306 the commercial property service application 110 calculates a valuation for the chosen type of commercial property.

In some embodiments, the public property information database 114 is accessible by the server 102, via the communication system 108. Public information pertaining to commercial property of interest may be accessed and retrieved from the public property information database 114 by the server 102. Thus, publicly available information for commercial property of interest may be stored into the commercial property for sale database 206 residing in the memory 104. In another embodiment, the publically available property information may be stored into a commercial property public information database 222. Thus, a separate database of publically available information may be available in a more reliable manner to clients of the commercial property valuation system 100. For example, if public information must be accumulated manually, or if access to a public server is potentially limited or fee based, the client will have access to the public information of interest that is provided by the commercial property service application 110.

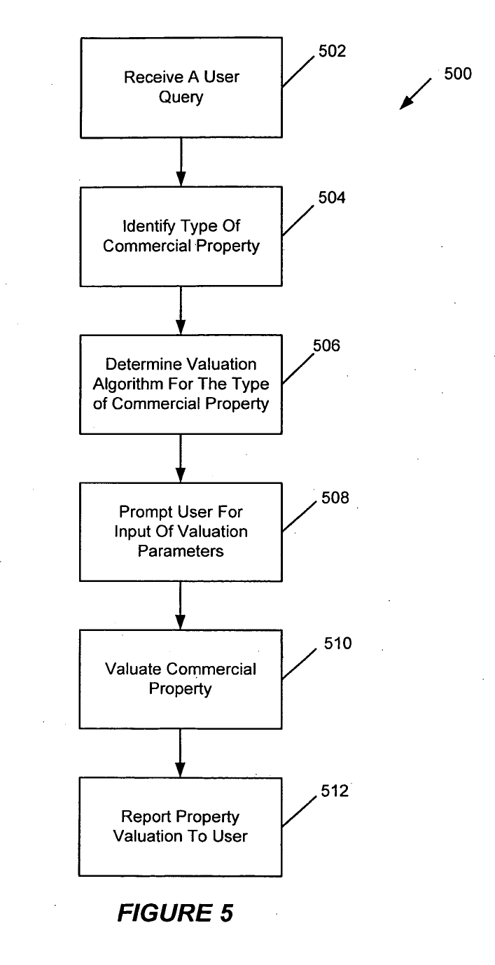

FIG. 5 is a flow chart 500 illustrating in further detail an exemplary process for calculating a value of a property used by an embodiment of the commercial property service application 110. The process begins at block 502 with receiving a query from a user. Based upon the information provided in the received user query, the type of the commercial property that the user is interested in is identified at block 504. At block 506, a valuation algorithm is selected based upon the identified type of commercial property, where the valuation algorithm is selected from a plurality of different valuation algorithms for different types of commercial property. The user is prompted to provide information for a plurality of valuation parameters that will be used by the valuation algorithm determined at block 508. At block 510, a valuation is determined for the commercial property based upon the user provided valuation parameters and based upon valuation parameters residing in the databases of the commercial property valuation system 100. A property valuation report is generated for the user at block 512.

A user initiates determination of a valuation of commercial property by communicating a query to the commercial property valuation system 100. The user, in an exemplary embodiment, generates the query at computer terminal 106. The initial query is communicated to the server 102, via communication system 108. Preferably, the query is based upon the GUI template 118 that is filled out by the user. The GUI template 118 is provided by the commercial property valuation system 100 when the user invokes a commercial property valuation process.

The user, via the GUI template 118, indicates a type of commercial property that is of interest. The user may indicate that they are a buyer, a seller, or just curious. Exemplary types of commercial property may include, but are not limited to, apartments, hospitality properties (hotels, motel, bed and breakfasts, etc.), industrial property, retail space, shopping center, office space, assisted or senior living facilities, self storage units, or vacant land.

In most instances, additional information is provided by the user via the GUI template 118, or a new GUI template 118 that is generated in response to the information from a previously received GUI template 118. For example, if the user indicates an interest in vacant land, further sub-types of vacant land may include agriculture, pasture, timberland, wetlands, brown field, industrial, or recreational. The user may also provide other information, such as the physical address of the commercial property of interest.

After the type of the commercial property of interest that the user is interested in is identified at block 504, a valuation algorithm is selected based upon the identified type of commercial property. The valuation algorithms, in an exemplary embodiment, reside in the commercial property valuation service application 204. However, the property valuation algorithms may reside in any suitable location. The valuation algorithms are applicable to different types of commercial property. A selected valuation algorithm may require additional relevant information from the user. Accordingly, one or more additional GUI templates 118 are presented to the user for input of specific valuation parameters.

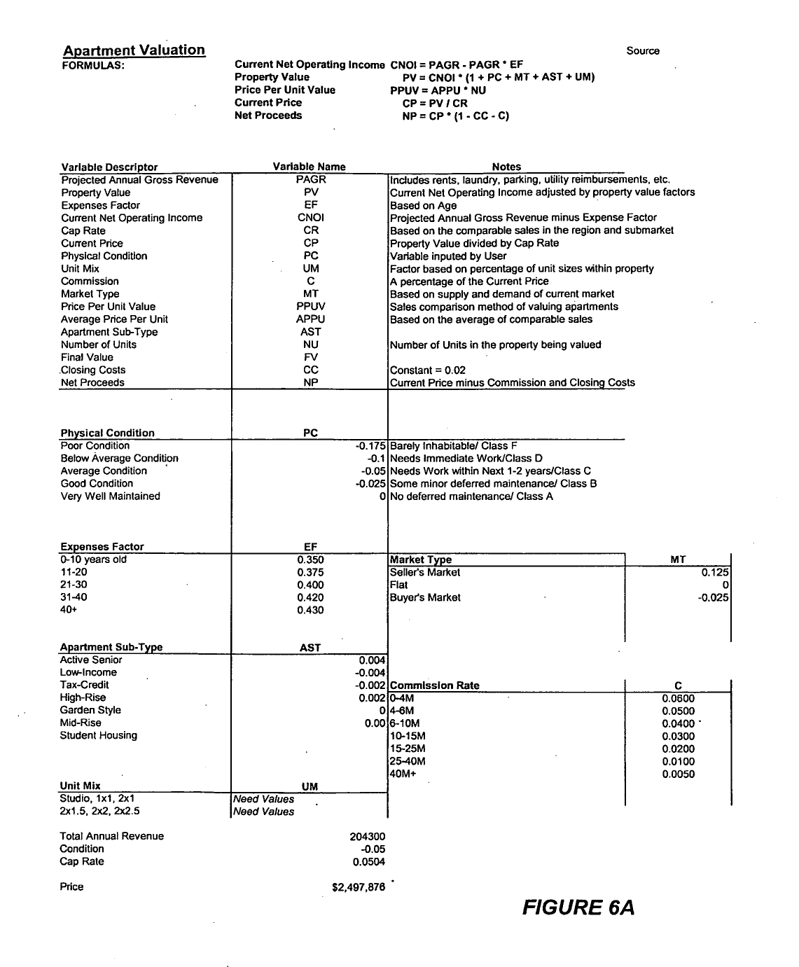

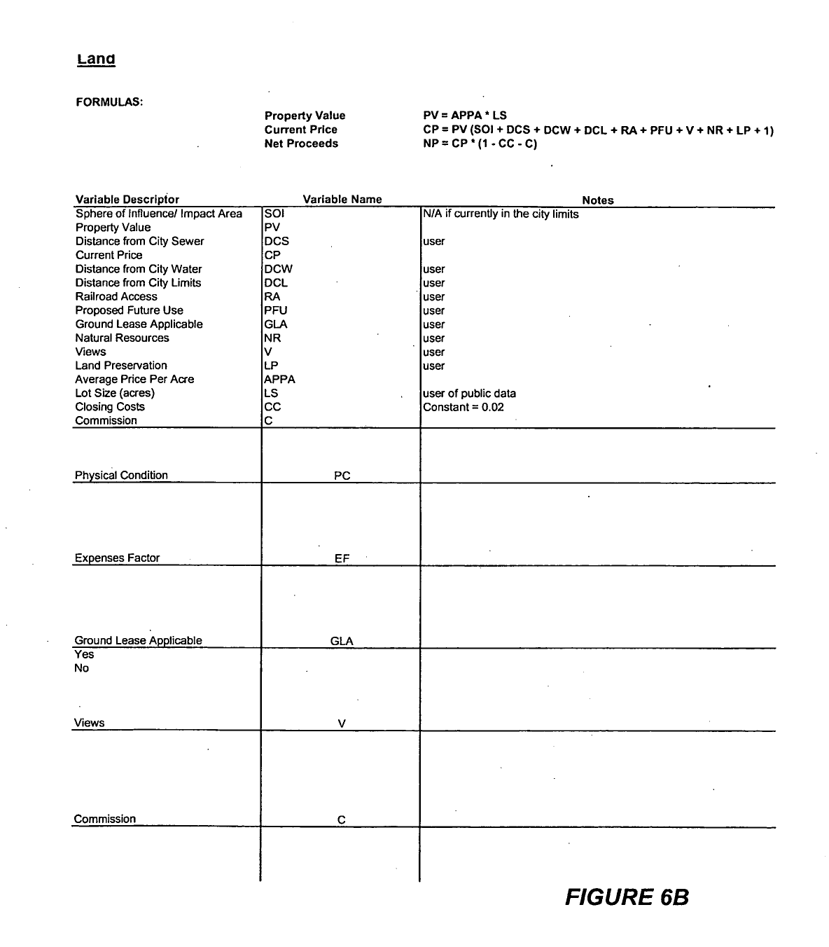

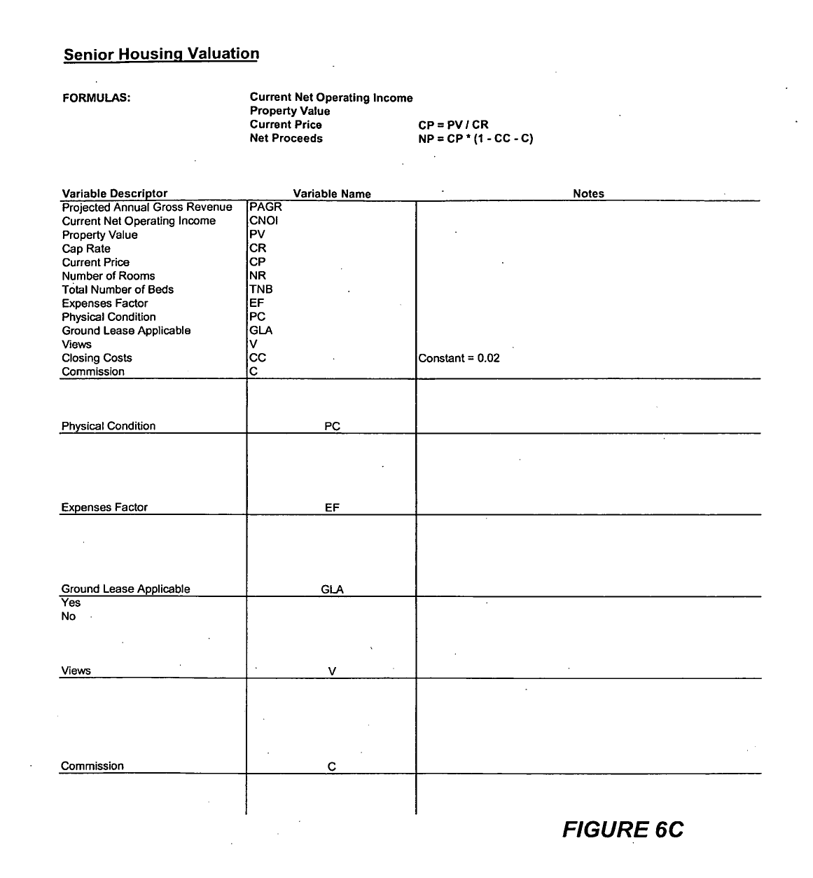

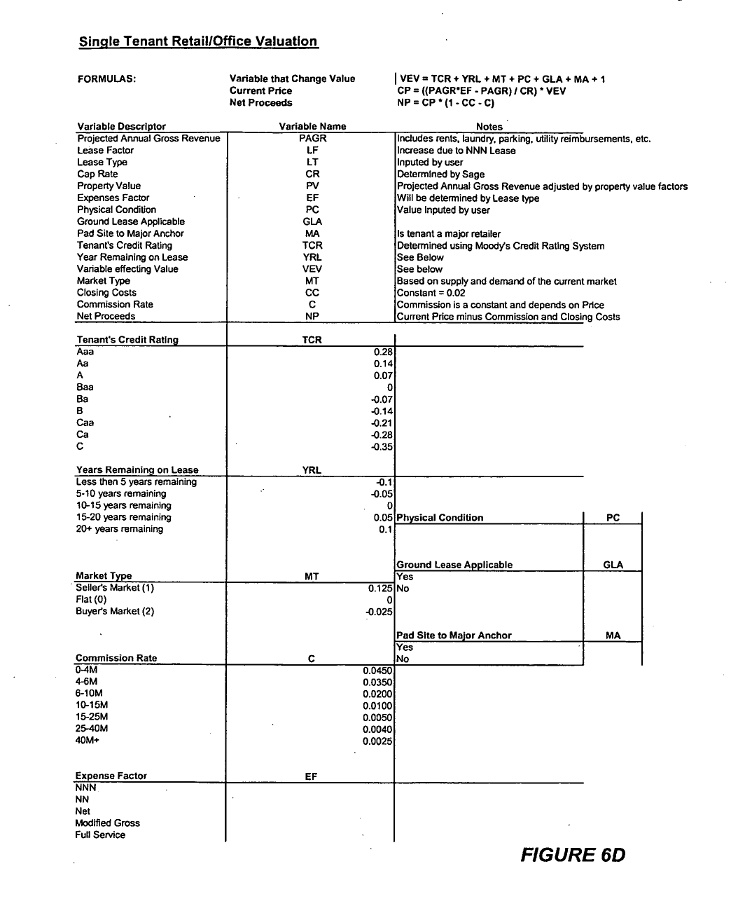

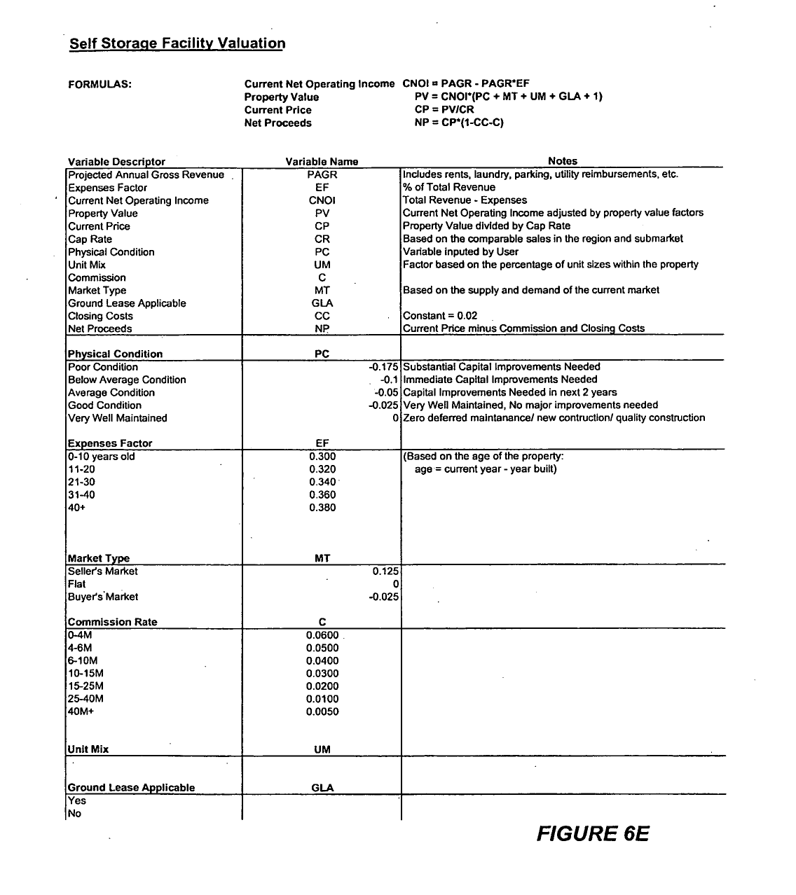

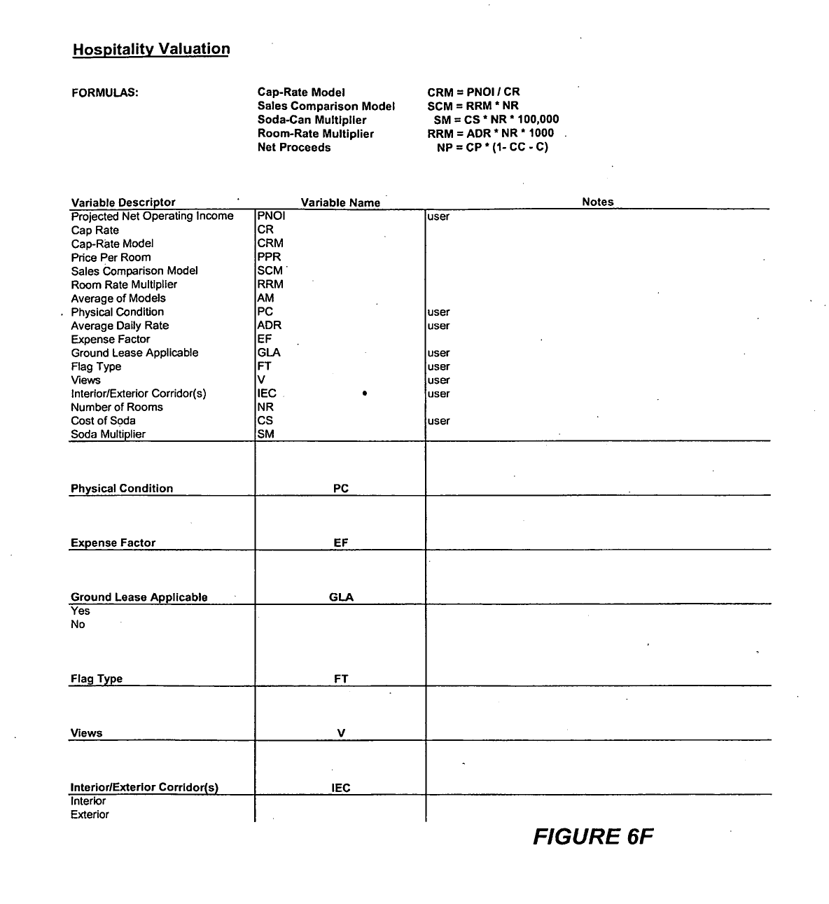

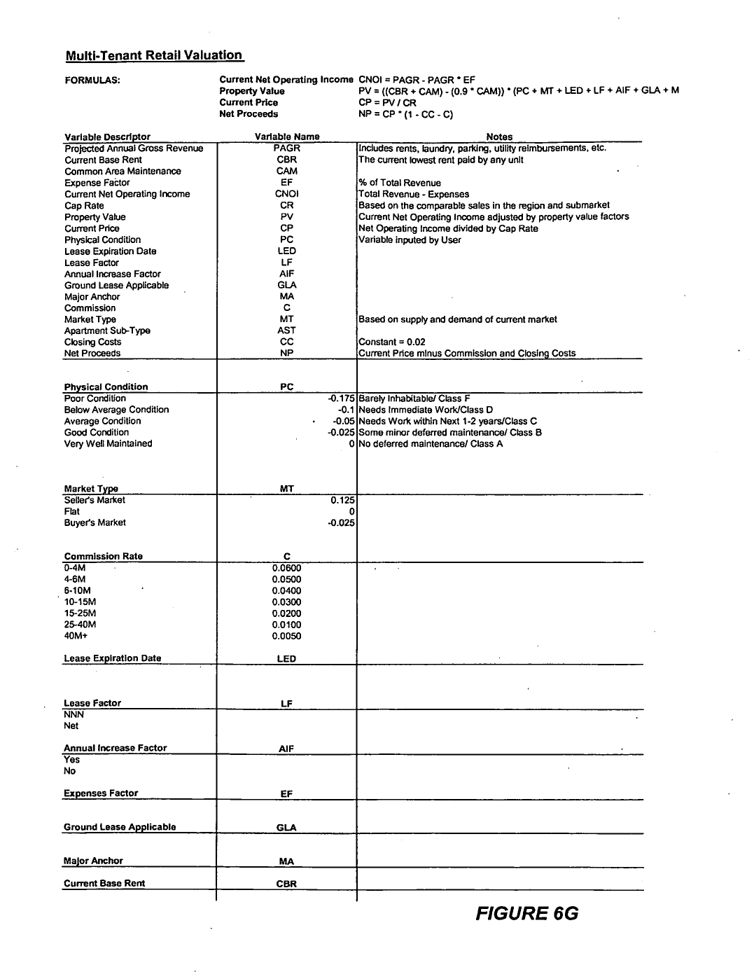

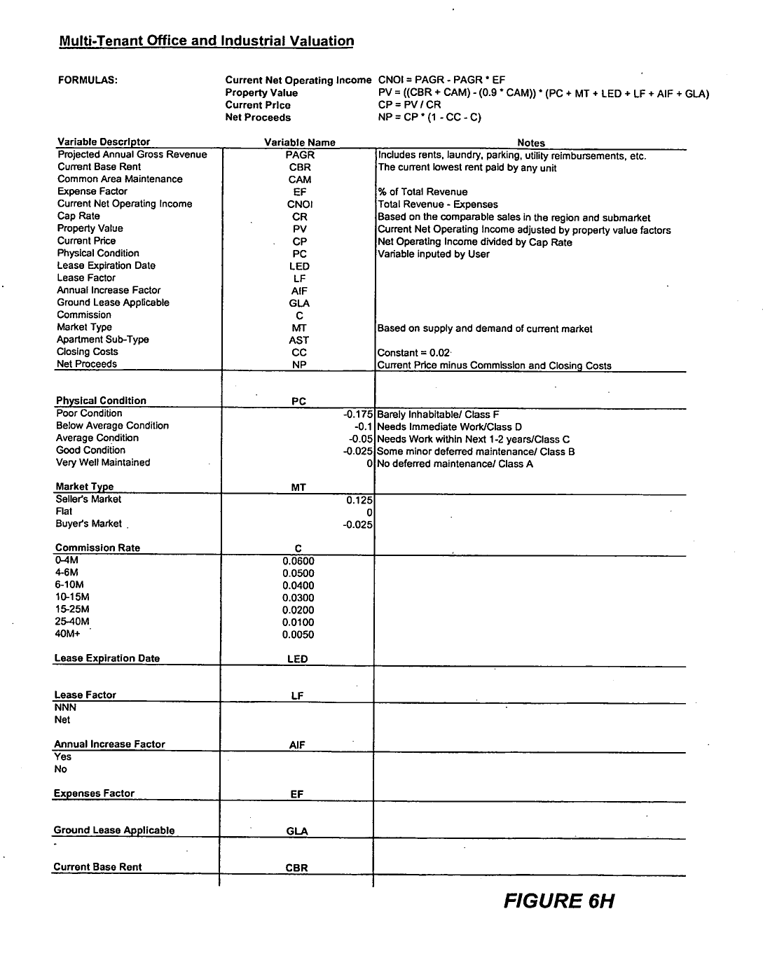

FIGS. 6A-6H illustrate exemplary commercial property valuation algorithms and valuation parameters for various commercial property types. The algorithms used to determine commercial property valuations employ a variety of valuation parameters that are particular to the type of commercial property being valued. Valuation parameters may be provided by the user, or may be provided by accessing the information available from the public property information database 114. For example, some valuation parameters, such as the assessed property value, may be stored in the commercial property public information database 222.

The valuation parameters may be objective valuation parameters or subjective valuation parameters. Objective valuation parameters have numeric values that represent a characteristic corresponding to the identified commercial property to be valued. That is, an objective valuation parameter is not subject to the subjective opinion of an individual. A non-limiting example of an objective valuation parameter is the year of construction if the commercial property of interest is a building.

Subjective valuation parameters are subject to the subjective opinion of an individual. Embodiments of the commercial property valuation system 100 objectify a subjective valuation parameter by assigning a numeric value to the objective valuation parameter. Accordingly, embodiments of the commercial property valuation system 100 are able to meet a heretofore unmet need in the industry by removing the effect of subjective opinions that may influence commercial property valuations that plague conventional commercial property valuation systems and methods. The objectification of the objective valuation parameters provides the surprising and unexpected result that commercial property valuations are more reliable. Further, property valuations between comparable types of commercial property, given similar objective parameters, are more consistent than the inconsistent commercial property valuations that plague conventional commercial property valuation systems and methods.

FIG. 6A illustrates an exemplary algorithm and valuation parameters for an apartment valuation. When apartment valuation is performed by embodiments of the commercial property valuation system 100, valuation parameters include values for the identified variable descriptors. In addition, adjustments for the physical condition of the apartment is considered. Physical condition is a subjective valuation parameter. Embodiments of the commercial property valuation system 100 assign a numerical parameter to account for the physical condition based on the input condition.

Expected expenses for maintaining the identified commercial property may also be a subjective valuation parameter. Embodiments of the commercial property valuation system 100 assign a numerical parameter to account for the expected expenses of operating and maintaining the apartment based on the year of construction, and based upon a numerical value corresponding to expected expenses for commercial properties based on age.

Other valuation parameters are also factored into the value determination algorithm. For example, apartment sub-type, unit mix, and commission rate may be used to value the apartment. With respect to the unit mix, the “needs values” indicia indicates that in the various embodiments of the commercial property valuation system 100, valuation parameters may be changed. Similarly, the indicated numerical values for the illustrated valuation parameters may be modified. Here, an administrator may set any of the values that are used to value the property. Thus, embodiments are very dynamic and can be adjusted according to changing economic conditions, different geographic markets, and other considerations.

FIG. 6B illustrates an exemplary algorithm and valuation parameters for a vacant land valuation. In this example, various valuation parameters provided by the user are shown. Accordingly, a suitable GUI template 118 is generated and presented to the user. When the user has provided the information via the completed GUI template 118, the valuation process is performed.

One of the exemplary parameters is “Views” which corresponds to any views that the land may have. For example, land may have views of mountains, oceans, lakes, rivers, parks, city sky lines, and/or other desirable terrain features. Embodiments of the commercial property valuation system 100 assign a numeric valuation parameter to this objective type of information. The parameter may be adjustable to reflect local market conditions. For example, an ocean front view may be assigned a relatively high numeric value, whereas a distance or partial ocean view may be assigned a different numeric value.

Another valuation parameter relative to valuation of land pertains to valuable natural resource rights that are attached to and run with the land, such as mineral rights, timber rights, and/or water rights. Specific values of these rights may be entered by the user or from another suitable source. Or, these types of factors may be subjective if there is no economic value associated with the information. Embodiments of the commercial property valuation system 100 assign a numeric valuation parameter to this objective type of information. The parameter may be adjustable to reflect local market conditions.

Another objective factor is proximity to public services, such as sewer, water, electricity, phone service, and/or transportation facilities. Proximity to a road or highway may greatly influence valuation, for example. Costs to construct an access road or to install utility services may be estimated, or specifically entered, and then included in the valuation algorithm. Alternatively, or additionally, numerical values may be determined based upon historical information available for other related types of properties. This information may be earlier stored and then retrieved for use from a suitable database.

In some situations, predefined zoning classifications are considered as a valuation parameter. For example, land zoned for multiple use, commercial use, agricultural use, or high density residential use are all valuated using applicable numerical values to arrive at a calculated commercial property value. These types of factors are subjective in that there is no economic value associated with the information. Embodiments of the commercial property valuation system 100 assign a numeric valuation parameter to this objective type of information. The parameter may be adjustable to reflect local market conditions. Alternatively, or additionally, numerical values may be determined based upon historical information available for other related types of properties. This information may be earlier stored and then retrieved for use from a suitable database.

FIG. 6C illustrates an exemplary algorithm and valuation parameters for a senior housing valuation. Factors such as current net operating income are considered. Net operating income may be directly provided, or alternatively, may be estimated based upon historical occupancy rates or the like. These types of factors may be subjective if there is no economic value for the net operating income. Embodiments of the commercial property valuation system 100 then assign a numeric valuation parameter to this objective type of information. The parameter may be adjustable to reflect local market conditions. Alternatively, or additionally, numerical values may be determined based upon historical information available for other related types of properties. This information may be earlier stored and then retrieved for use from a suitable database.

FIG. 6D illustrates an exemplary algorithm and valuation parameters for a single tenant retail and/or office valuation. If the commercial property has existing tenants, the income provided by the tenants and the years remaining on the current lease are objective valuation parameters that impact property valuations. However, the quality of the tenant is an objective valuation parameter. Embodiments of the commercial property valuation system 100 assign a numerical value to tenant quality, thereby removing the subjectivity of this valuation parameter. Alternatively, or additionally, numerical values may be determined based upon historical information available for other related types of properties. This information may be earlier stored and then retrieved for use from a suitable database.

Market type is another objective valuation parameter. In good economic times, the market may be classified as a seller's market. Accordingly, valuation prices may be adjusted upward. In hard economic times, the market may be classified as a buyer's market. Accordingly, valuations may be adjusted downward. Market type is a subjective valuation parameter. Accordingly, embodiments of the commercial property valuation system 100 assign a numerical value to market type, thereby removing the subjectivity of this valuation parameter.

Another valuation parameter is the presence, or absence, of an an anchor tenant. For example, if the commercial property valuation system 100 is valuing a single unit retail lease price in a shopping mall, a large nationally-branded retailer may have a positive effect on the lease valuation. Embodiments of the commercial property valuation system 100 assign a numerical value to anchor tenants, thereby removing the subjectivity of this valuation parameter.

FIG. 6E illustrates an exemplary algorithm and valuation parameters for a self storage facility valuation. FIG. 6F illustrates an exemplary algorithm and valuation parameters for a hospitality valuation. FIG. 6G illustrates an exemplary algorithm and valuation parameters for a multi-tenant retail valuation. FIG. 6H illustrates an exemplary algorithm and valuation parameters for a multi-tenant office and/or industrial valuation.

It is appreciated that any suitable valuation algorithm may be devised for embodiments of the commercial property valuation system 100, wherein objective and subjective valuation parameters are numerically processed to determine a commercial property valuation. Further, embodiments of the commercial property valuation system 100 are configured to assign a numerical value to subjective valuation parameters, thereby removing the subjectivity of the subjective valuation parameter.

Some embodiments of the commercial property valuation system 100 adjust commercial property valuations based on geographic specific sales information. One embodiment harvests assessed values and corresponding sales prices for commercial property. Assessment valuation factors may also be obtained from the public property information database 114. For example, but not limited to, property address, property size, property zoning, days on the market during a pending sale, and/or number of units, may be obtained.

The properties may be grouped by commercial property type, specific location, and/or other characteristics. A historical ratio of assessed value to sales price is then determined for each property. When a plurality of commercial properties are grouped together, the historical ratios may be averaged to arrive at a composite historical average. Date of the information may be used to weight the ratios. For example, a very recent assessment and/or sale price may be given a greater weight than a relatively old assessment and/or sale price. The commercial property valuation service application 204 may then fine tune valuations for a the commercial property of interest by factoring in the effect of the historical ratios. Thus, any of the above-described exemplary algorithms may be optionally modified to include the effect of the historical ratio information.

A capitalization rate is used in the property valuation algorithms. Based upon a known cash flow that is generated by the commercial property of interest, its determined present value may be used to calculate the capitalization rate (CP). The commercial property valuation service application 204 may then fine tune valuations for the commercial property of interest by factoring in the effect of the historical capitalization rates. Thus, any of the above-described exemplary algorithms may be optionally modified to include the effect of the historical capitalization rate.

Returning to FIG. 5, after the valuation is determined for the commercial property of interest, a property valuation report is generated for the user at block 512. The valuation information may be presented to the user in any suitable format. For example, a new GUI template 118 may be generated and presented on the computer terminal 106.

Additionally, other information of interest may be provided. For example, the user may obtain estimations of an annualized rate of return for the commercial property of interest.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for valuing commercial properties, the method comprising:
identifying a type of commercial property based on an identified commercial property, the identified type of commercial property selected from a list of property types;
retrieving a plurality of objective valuation parameters and subjective valuation parameters pertaining to the identified type of commercial property;
retrieving at least one valuation parameter for the identified commercial property; and
valuing the identified commercial property based upon the at least one valuation parameter for the identified commercial property and based upon the plurality of objective valuation parameters and subjective valuation parameters pertaining to the identified type of commercial property.

2. The method of claim 1, further comprising:
assigning a value to each subjective valuation parameter, wherein the valuation of the identified commercial property is based upon the assigned value for each subjective valuation parameter.

3. The method of claim 2, wherein the subjective valuation parameter is an expected expense for maintaining the identified commercial property, and comprising:
retrieving the age of the identified commercial property; and
assigning a value to the expected expense for maintaining the identified commercial property based upon the age.

4. The method of claim 2, wherein the subjective valuation parameter is a view of terrain from the identified commercial property, and comprising:
retrieving a description of the view for the identified commercial property; and
assigning a value to the view.

5. The method of claim 2, wherein the subjective valuation parameter is a current market condition for real estate sales in a geographic region of the identified commercial property, and comprising:
retrieving an address of the identified commercial property; and
assigning a value to the current market condition for real estate sales based upon the address.

6. The method of claim 2, wherein the subjective valuation parameter is presence of an anchor tenant in proximity to the identified commercial property, and comprising:
retrieving an identification of the anchor tenant in proximity to the identified commercial property; and
assigning a value to the identified anchor tenant.

7. The method of claim 2, wherein the subjective valuation parameter is a tenant quality occupying the identified commercial property, and comprising:
retrieving a description of a quality of a tenant occupying the identified commercial property; and
assigning a value to the tenant quality based upon the quality of the tenant.

8. The method of claim 2, wherein the subjective valuation parameter is the presence of any lease agreement attached to an identified commercial property, and comprising:
retrieving a description of the lease attached to the identified commercial property; and
retrieving the length of time remaining on the lease); and
retrieving the annual increases in rent for applicable commercial property; and
assigning a value to the lease type, length of the lease and remainder of the lease.

9. The method of claim 2, wherein the subjective valuation parameter is an expected physical condition for the identified commercial property, and comprising:
retrieving the physical condition of the identified commercial property; and
assigning a value to the current physical condition of the identified commercial property.

10. The method of claim 2, wherein the subjective valuation parameter is the rentable square feet for the identified commercial property, and comprising:
retrieving the unit mix details for a identified commercial property defined as the total number of rentable spaces/rooms or units within a identified commercial property; and
retrieving the total square feet of each rentable space/room or unit within a identified commercial property; and assigning a value to the rentable square footage and number of spaces/rooms/units assigned to the identified commercial property.

11. The method of claim 2, wherein the subjective parameter is the flag type of an identified lodging type, and comprising:
retrieving the flag type for the identified lodging type from the user; and assigning a value to the flag listed.

12. The method of claim 2, wherein the subjective parameter is whether the lodging type of claim 11 provides guests access to rooms via an exterior corridor or an interior corridor, and comprising:
retrieving from the user if a hotel or motel provides exterior corridor access or interior corridor access to the rooms; and assigning a value to a hotel or motels corridor type.

13. The method of claim 1, further comprising:
receiving an address identifying the identified commercial property.

14. The method of claim 1, wherein the subjective valuation parameter comprises at least one selected from a group consisting of a view of terrain from the identified commercial property, an expected expense for maintenance of the identified commercial property based upon an age of the identified commercial property, a current market condition for real estate sales in a geographic region of the identified commercial property, a tenant quality occupying the identified commercial property, a presence of an anchor tenant in proximity to the identified commercial property, a presence of a lease agreement identifying the lease term length and annual rental increase provisions, a current physical condition for the identified commercial property, total rentable square feet of the identified commercial property, and lodging type, and a lodging corridor type.

15. A system for valuing commercial properties, comprising:
a means for identifying a type of commercial property based on an identified commercial property, the identified type of commercial property selected from a list of property types;
a means for retrieving a plurality of objective valuation parameters and subjective valuation parameters pertaining to the identified type of commercial property;
a means for retrieving at least one valuation parameter for the identified commercial property; and
a means for valuing the identified commercial property based upon the at least one valuation parameter for the identified commercial property and based upon the plurality of objective valuation parameters and subjective valuation parameters pertaining to the identified type of commercial property.

16. The method of claim 15, further comprising:
a means for assigning a value to each subjective valuation parameter, wherein the valuation of the identified commercial property is based upon the assigned value for each subjective valuation parameter.

17. A system for valuing commercial properties, comprising:
a server configured to receive an identification of a commercial property of interest;
a memory; and
a processor system configured to:
retrieve the identification of a commercial property of interest;
identify a type of commercial property based on an identified commercial property, the identified type of commercial property selected from a list of property types residing in the memory;
retrieve a plurality of objective valuation parameters and subjective valuation parameters pertaining to the identified type of commercial property residing in the memory;
retrieve at least one valuation parameter for the identified commercial property; and
value the identified commercial property based upon the at least one valuation parameter for the identified commercial property and based upon the plurality of objective valuation parameters and subjective valuation parameters pertaining to the identified type of commercial property.

18. The system of claim 17, wherein the processor system is further configured to assign a value to each subjective valuation parameter, wherein the valuation of the identified commercial property is based upon the assigned value for each subjective valuation parameter.

19. The system of claim 17, wherein the at least one objective valuation parameter is provided by a user.

20. The system of claim 17, wherein the at least one objective valuation parameter is retrieved from the memory.
